(19) United States
(12) Patent Application Publication
(10) Pub. No.: US 2025/0128761 A1
(43) Pub. Date: Apr. 24, 2025

(54) PARKING ASSISTANCE DEVICE, PARKING ASSISTANCE METHOD, AND NON-TRANSITORY COMPUTER-READABLE RECORDING MEDIUM WITH PARKING ASSISTANCE PROGRAM RECORDED THEREON

(71) Applicant: Panasonic Automotive Systems Co., Ltd., Kanagawa (JP)

(72) Inventors: Hong HEO, Kanagawa (JP); Hirofumi NISHIMURA, Kanagawa (JP); Yoshimasa OKABE, Kanagawa (JP)

(73) Assignee: Panasonic Automotive Systems Co., Ltd., Kanagawa (JP)

(21) Appl. No.: 18/917,392

(22) Filed: Oct. 16, 2024

(30) Foreign Application Priority Data
Oct. 18, 2023 (JP) 2023-179790

(51) Int. Cl. B62D 15/02; G06V 10/40

(52) U.S. Cl. CPC B62D 15/0285; G06V 10/40

(57) ABSTRACT

The parking assistance device includes a feature point detector that determines whether a first number of a plurality of feature points extracted from a camera image captured at a start position for automatic parking of a vehicle during the automatic parking is equal to or greater than a third number that is greater than a second number of a plurality of feature points extracted from a camera image captured at the start position during learning travel, and a traveling controller that controls the vehicle not to perform the automatic parking when the first number is equal to or greater than the third number.

### TECHNICAL FIELD

The present disclosure relates to a parking assistance device, a parking assistance method, and a non-transitory computer-readable recording medium with a parking assistance program recorded on.

### BACKGROUND ART

Conventionally, there has been known a technology in which position estimation is performed while taking an imaging environment into consideration when a vehicle performs automatic parking. For example, Patent Literature (hereinafter, referred to as PTL) 1 discloses a position estimation system that does not perform the position estimation when the number of features included in a feature group of a map is equal to or less than a threshold in the position estimation processing. This position estimation system can prevent vehicle 1 from being parked by the automatic parking function based on a position with relatively poor estimation accuracy.

### CITATION LIST

### Patent Literature

### PTL 1

Japanese Patent Application Laid-Open No. 2019-133318

### SUMMARY OF INVENTION

### Technical Problem

Even when the number of features included in the map feature group is greater than the threshold, however, there is still a possibility of mistakenly recognizing an object around a vehicle. In the technique of PTL 1, the case described above is not considered, and thus, automatic parking is performed while there is a possibility of misrecognition.

The present disclosure is intended to solve the above-described problem, and an object of the present disclosure is to provide a parking assistance device, a parking assistance method, and a parking assistance program that further reduce the risk in automatic parking.

### Solution to Problem

In order to solve the above-described problem, one aspect of the parking assistance device according to the present disclosure includes: a feature point detector that determines whether a first number of a plurality of feature points extracted from a camera image captured at a start position for automatic parking of a vehicle, during the automatic parking, is equal to or greater than a third number that is greater than a second number of a plurality of feature points extracted from a camera image captured at the start position during learning travel; and a traveling controller that controls the vehicle not to perform the automatic parking when the first number is equal to or greater than the third number.

One aspect of the parking assistance method according to the present disclosure includes: feature-point detecting of determining whether a first number of a plurality of feature points extracted from a camera image captured at a start position for automatic parking of a vehicle, during the automatic parking, is equal to or greater than a third number that is greater than a second number of a plurality of feature points extracted from a camera image captured at the start position during learning travel; and travel controlling of controlling the vehicle not to perform the automatic parking when the first number is equal to or greater than the third number.

One aspect of a non-transitory computer-readable recording medium, according to the present disclosure, stores thereon a parking assistance program for causing a computer to execute processing, the processing including: feature-point detecting of determining whether a first number of a plurality of feature points extracted from a camera image captured at a start position for automatic parking of a vehicle, during the automatic parking, is equal to or greater than a third number that is greater than a second number of a plurality of feature points extracted from a camera image captured at the start position during learning travel; and travel controlling of controlling the vehicle not to perform the automatic parking when the first number is equal to or greater than the third number.

### Advantageous Effects of Invention

According to the present disclosure, it is possible to reduce the risk in automatic parking.

### BRIEF DESCRIPTION OF DRAWINGS

FIG. 1 illustrates a vehicle to which a parking assistance device according to the present embodiment is applicable;

FIG. 2 is a block diagram illustrating the parking assistance device according to the present embodiment;

FIG. 3 illustrates a hardware configuration of the parking assistance device according to the present embodiment;

FIG. 4 is a flowchart of a learning travel according to the present embodiment;

FIG. 5 illustrates feature points of a parking space according to the present embodiment;

FIG. 6 is a flowchart of automatic parking according to the present embodiment;

FIG. 7 illustrates a comparison of the feature points according to the present embodiment;

FIG. 8 illustrates feature points of the parking space according to the present embodiment;

FIG. 9 illustrates a comparison of the feature points according to the present embodiment;

FIG. 10 illustrates feature points of the parking space according to the present embodiment;

FIG. 11 illustrates a comparison of the feature points according to the present embodiment;

FIG. 12 illustrates feature points of the parking space according to the present embodiment; and

FIG. 13 illustrates a comparison of the feature points according to the present embodiment.

### DESCRIPTION OF EMBODIMENTS

Hereinafter, embodiments of the present disclosure will be described with reference to the drawings. Embodiments described below are all specific examples of the present disclosure. Therefore, each component, the position of each component and the connection form, as well as each step and the order of the steps, and the like, shown in the following embodiments are examples and are not intended to limit the present disclosure. In addition, components in the following embodiments that are not described in the independent claims are described as optional components.

Each drawing is a schematic diagram and is not necessarily a strict illustration. In the drawings, the same symbol is attached to a substantially identical configuration, and redundant explanations are omitted or simplified.

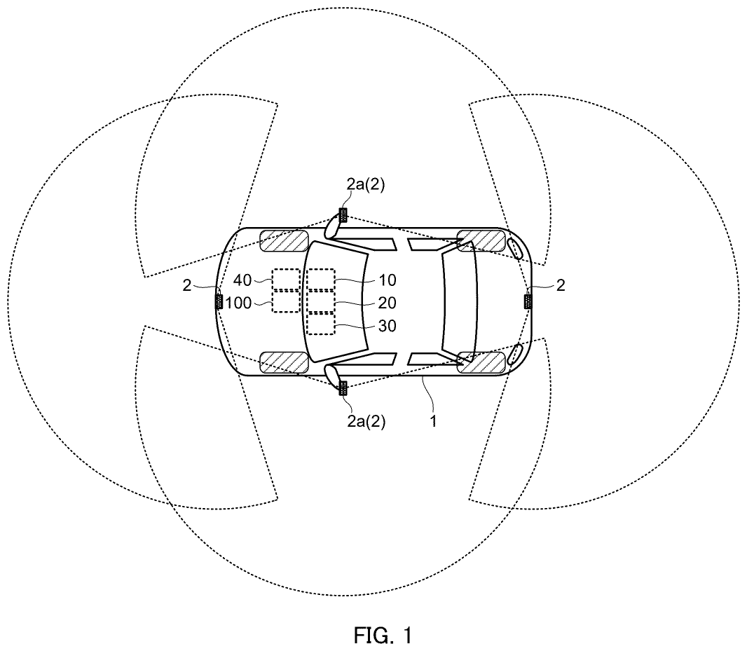

FIG. 1 illustrates a vehicle to which a parking assistance device according to the present embodiment is applicable. In the learning type automatic parking, vehicle 1 is manually parked and the parking start position and parking route are stored in vehicle 1 during learning travel, and vehicle 1 automatically travels from the parking start position along the parking route to park vehicle 1 during automatic parking.

More specifically, vehicle 1 including parking assistance device 100 performs, in a learning travel in which parking is performed manually, extraction of feature points included in a camera image captured by camera 2 and generation of a map including information on the feature points and information on the parking route, and performs automatic parking by traveling while estimating the position and the posture of vehicle 1 using the map.

Cameras 2 are provided at four locations of the front, rear, left, and right sides of the vehicle body of vehicle 1. Each camera 2 includes a fish-eye lens and has a field of view of 180 degrees or more in the horizontal direction (see broken line). Parking assistance device 100 specifies the position of an object captured in the camera image and the direction of the object as viewed from vehicle 1 based on the extracted feature points.

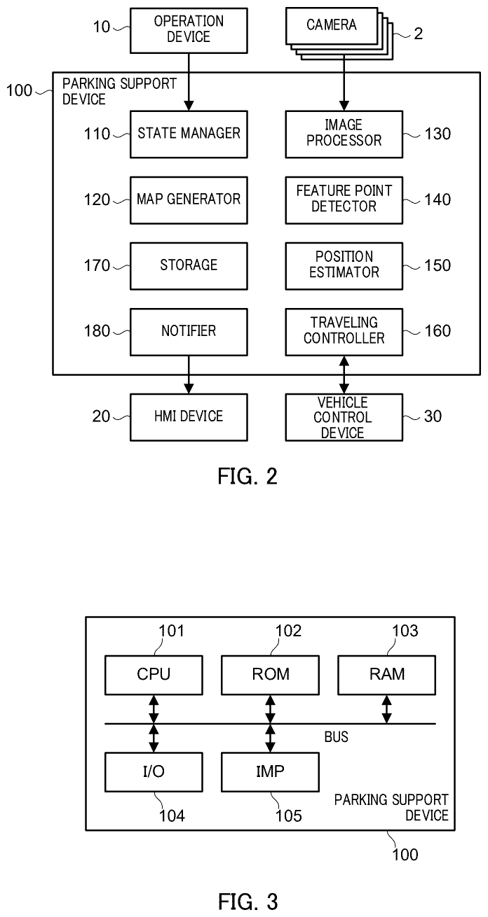

FIG. 2 is a block diagram illustrating parking assistance device 100 according to the present embodiment. Parking assistance device 100 includes state manager 110, map generator 120, image processor 130, feature point detector 140, position estimator 150, traveling controller 160, storage 170, and notifier 180. Further, cameras 2, operation device 10, Human Machine Interface (HMI) device 20, and vehicle control device 30 are connected to parking assistance device 100.

Camera 2 outputs a camera image that captured the surroundings of vehicle 1. Image processor 130 receives the camera image and performs generation of a display image to be displayed on HMI device 20, and the like. The display image is output from notifier 180 to HMI device 20.

Notifier 180 causes HMI device 20 to display a message or causes a (not illustrated) speaker to output a voice message. State manager 110 receives a user operation through operation device 10, and controls the functions of parking assistance device 100 according to the user operation. Operation device 10 is, for example, a touch panel of navigation device 40.

State manager 110 receives the position information from the main body (not illustrated) of navigation device 40. When performing a learning travel, state manager 110 adds position information to the map and records the information in storage 170, and when performing automatic parking, compares the position (GPS) information of navigation device 40 with the position information added to the map, thereby selecting the map to be used.

Image processor 130 generates an image for detection (also referred to as “detection image”) in addition to the display image. The detection image is an image in which, for example, a change in brightness or color is emphasized. Feature point detector 140 extracts information on a feature point from the detection image. A feature point is, for example, a point that is located at a corner or an edge of an object captured in a camera image, rather than points on a surface or a side of the object. The information on the feature points includes information on the color and the shape of an object captured in a camera image and information on the positions of the feature points on the camera image.

When the learning travel is started, map generator 120 stores in storage 170 feature points detected at the start position of the learning travel. The information on the feature points at this start position is necessary to identify the position and the posture of vehicle 1 at the time of starting the automatic parking.

When vehicle 1 starts traveling, map generator 120 tracks the position of a feature point on the camera image. For example, as illustrated in FIG. 1, map generator 120 compares feature points captured in a camera image at time A with feature points captured in a camera image at time B later than time A, and detects pairs of feature points whose information on the position, the color, or the shape of the feature points matches. This is called tracking.

The change in the position of the paired feature points on the camera image is generated by the movement amount and the posture change of vehicle 1 between time A and time B, and therefore the three-dimensional coordinates of the feature points can be identified based on the principle of triangulation.

Further, map generator 120 generates a map including information on feature points and information on a parking route. Storage 170 stores the information of the map.

When the automatic parking is performed, feature point detector 140 detects feature points that match a map by collating information on the feature point detected by feature point detector 140 (information on the color and the shape of an object captured in the camera image, and information on the positions of feature points on the camera image) with information on the feature points registered in the map.

Since the position of a feature point on the camera image indicates the angle at which the feature point is visible from vehicle 1, position estimator 150 can estimate the position and the posture of vehicle 1 from the feature point on the map and the angle of the feature point on the camera image that matches the feature point on the map. This process is called self-position estimation, and a process of identifying feature points that match each other will be called a matching process. Self-position estimation and the matching process may be processed using an existing technique, and thus, a detailed description thereof will be omitted.

During learning travel, traveling controller 160 communicates with vehicle control device 30, acquires information on the rotation speed of the wheels and the steering angle, and calculates the amount of movement and the movement direction of the vehicle. The rotation speed and the steering angle of the wheel, or the amount of movement and the movement direction of the vehicle are registered in the map as information on the parking route.

When performing automatic parking, traveling controller 160 outputs an instruction signal to vehicle control device 30 so as to reproduce the steering angle that is obtained during learning travel. That is, the parking route used when automatic parking is performed is a reproduction of a parking route obtained during the learning travel.

When the position or the posture of the vehicle is shifted from that at the time of learning travel, traveling controller 160 first controls the steering angle to change the course such that the course intersects with the route at the time of learning travel, and when the vehicle coincides with the route of the learning travel, traveling controller 160 controls the steering angle such that the posture of the vehicle matches the posture of the learning travel. That is, traveling controller 160 estimates the position and posture of the vehicle, and feedback-controls the steering angle such that the course of vehicle follows the route of the learning travel.

FIG. 3 illustrates the hardware configuration of parking assistance device 100 according to the present embodiment. The functions of parking assistance device 100 may be mounted in hardware illustrated in FIG. 3. Parking assistance device 100 may be a computer including CPU 101, ROM 102, RAM 103, input/output interface (I/O) 104, and image processor (IMP) 105, with the elements being connected via a bus.

Parking assistance device 100 may accommodate a plurality of elements in one chip or may be configured by constituting one element with a plurality of chips. The bus does not have to be a single bus, and may be formed by combining a plurality of types of buses. For example, CPU 101, ROM 102, RAM 103, and IMP 105 may be accommodated in one chip and connected via a parallel bus, and I/O 104 may be configured with a plurality of chips and connected to the chip accommodating CPU 101 via a serial bus.

CPU 101 controls the entire parking assistance device 100. The function of each part of parking assistance device 100 may be mounted in the form of a program that is executed by CPU 101. ROM 102 and RAM 103 correspond to storage 170. ROM 102 is a nonvolatile memory, and RAM 103 is a volatile memory that is used as a temporary storage in a working area of CPU 101. For example, camera images such as a display image and a detection image, information on detected feature points, and the like are temporarily stored in RAM 103.

Further, IMP105 is a processor whose processing performance is increased by specializing in image processing and parallel processing, and the processing in image processor 130, feature point detector 140, position estimator 150, and the like may be executed by IMP105.

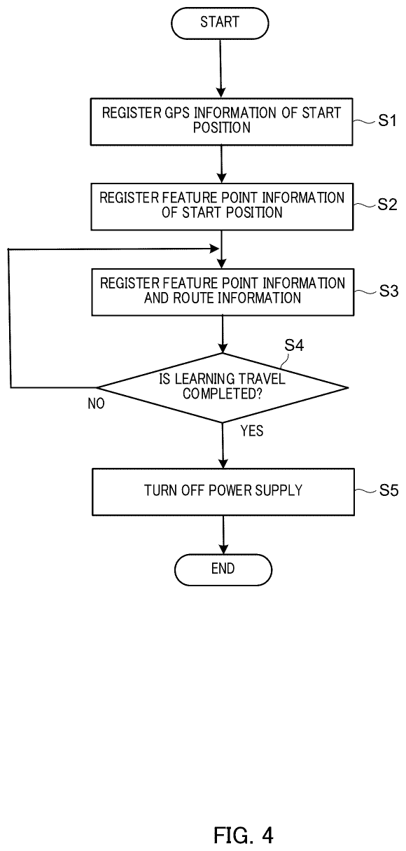

FIG. 4 is a flowchart of the learning travel according to the present embodiment. Information on an automatic parking route traveled by a driver is associated with GPS information and feature points at a registration start position of the route and is registered in storage 170 as map information.

In the learning travel, map generator 120 registers the GPS coordinates of the start position in storage 170 (step S1), and further registers information on the detected feature point (step S2).

At the start position of the learning travel in steps S1 and S2, map generator 120 acquires the GPS coordinates at the start position from navigation device 40, adds the information to the map information, and registers the information in storage 170 such that a map to be used can be identified from the GPS coordinates when automatic parking is performed. Further, in order to use the information on the feature points detected at the start position for the initial self-position estimation of the automatic parking, map generator 120 registers the information on the feature points detected at the start position in storage 170.

Map generator 120 tracks feature points and identifies the coordinates, and registers this information together with route information, such as a steering angle and a movement amount, as map information (step S3).

In step S3, between the start position and the parking position, map generator 120 tracks feature points, and for those feature points that have been successfully tracked, collects the coordinates of these feature points, adds that information to the map, and registers the information in storage 170. Further, map generator 120 register in storage 170 route information such as a steering angle, a vehicle speed, a gear position, a movement direction, a movement distance, and the like, as well as detection information on an obstacle.

Subsequently, map generator 120 determines whether the learning travel is completed or not (step S4). When the learning travel is not completed (step S4, NO), the processes in steps S3 and onward are performed. When the learning travel is completed (step S5, YES), the power supply of vehicle 1 is turned off, and the learning travel is ended.

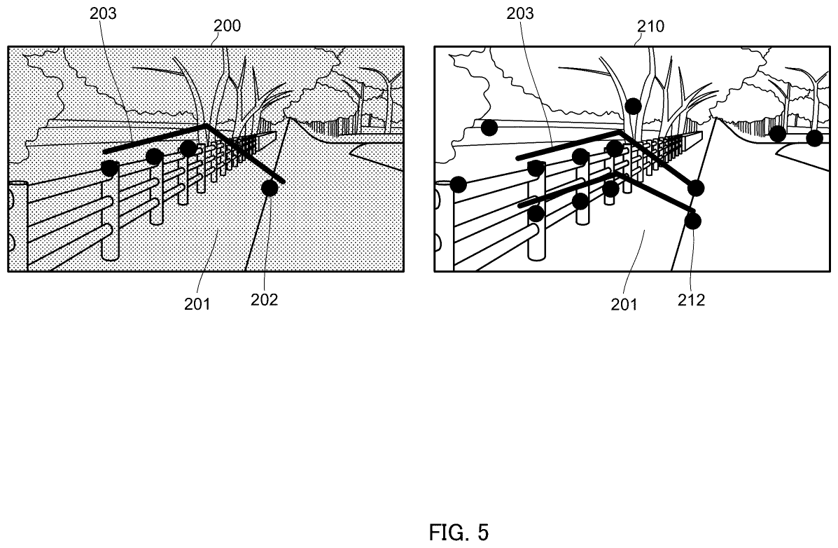

FIG. 5 illustrates feature points 202 and 212 of parking space 201 extracted from a camera image. The figure on the left side illustrates an example of feature points 202 extracted from camera image 200 captured during the learning travel at night, and the figure on the right side illustrates an example of feature points 212 extracted from camera image 210 captured during the automatic parking in the daytime.

Parking space 201 in front of the own home is shown in camera images 200 and 210, and feature points 202 registered for the route of the automatic parking is illustrated. Four feature points 202 are extracted in camera image 200 captured at night. Further, a total of 13 feature points 212 are displayed in camera image 210 captured in the daytime. Here, lines 203 are virtual lines for grasping the positions of feature points 202 and 212.

As the night turns into day and the brightness increases, the number of feature points 212 becomes greater than the number of feature points 202.

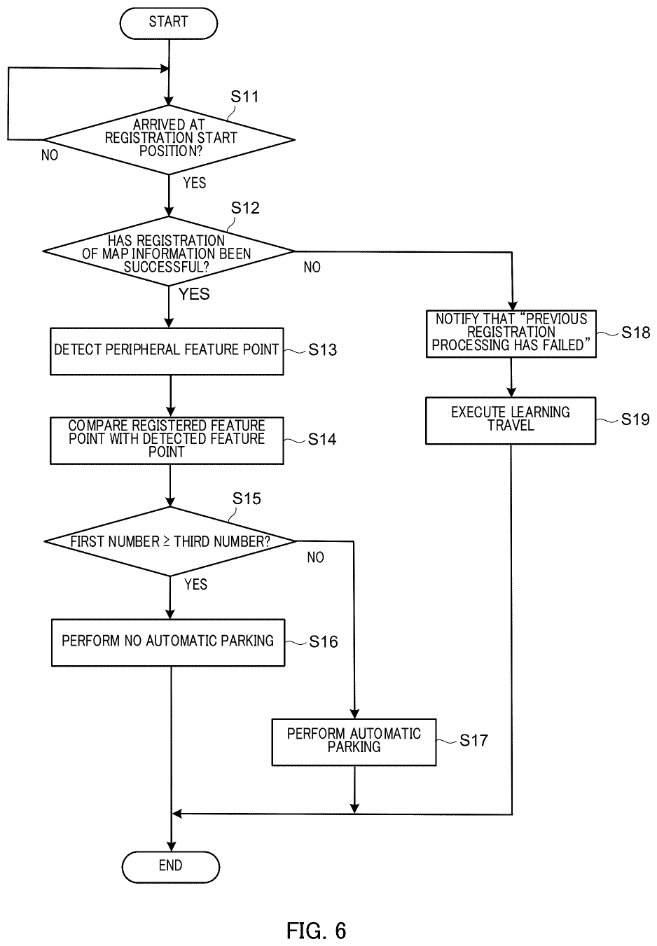

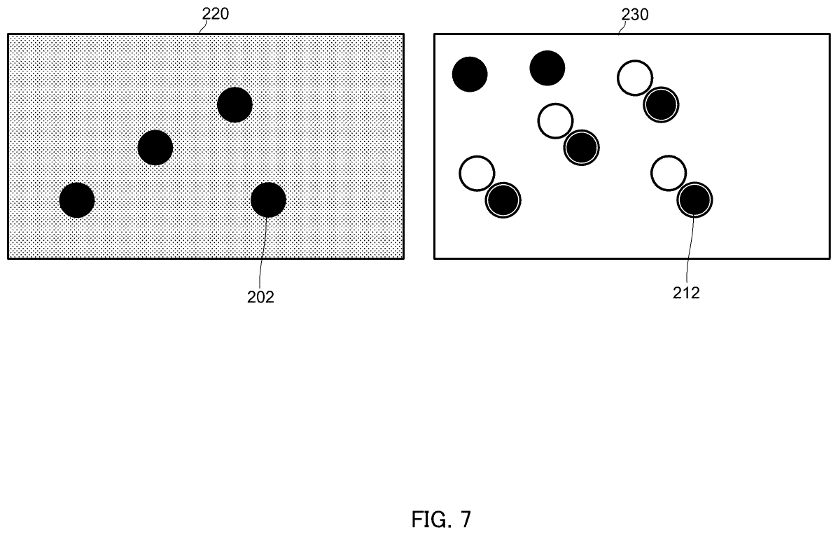

Next, automatic parking that uses a registered map and route information to reproduce a route will be described. FIG. 6 is a flowchart of the automatic parking according to the present embodiment.

First, state manager 110 determines whether vehicle 1 arrives at a registration position registered as the start position for the learning travel by using GPS information (step S11).

In this determination, state manager 110 may determine whether vehicle 1 has returned home based on whether the traveling direction obtained during the learning travel coincides with the traveling direction of vehicle 1, or whether vehicle 1 has approached the region of the traveling route obtained during the learning travel from a region other than the region of the traveling route obtained during the learning travel; and when vehicle 1 has returned home, state manager 110 may execute the processing of step S11.

When vehicle 1 does not arrive at the registration position (step S11, NO), the process in step S11 is repeated.

When vehicle 1 arrives at the registration position (step S11, YES), state manager 110 determines whether the registration of the map information by the learning travel has been successful (step S12).

The map information to be used when performing automatic parking is generated by executing a series of processes from extracting a plurality of feature points from a camera image captured (at the start position for the automatic parking) during learning travel up to registering the extracted feature points in storage 170. However, such a process of map information generation may be completed after the ignition of vehicle 1 is turned off, and thus, there is a possibility that the map information is not generated and the generation fails for some reason.

State manager 110 determines that the registration of the map information is successful when such a map information generation process is completed to the end, and turns the completion flag on. Further, state manager 110 determines that the registration of the map information fails when the generation process is not completed to the end, and turns the completion flag off.

As will be described below, when the registration of the map information fails during the learning travel, there is a high possibility that the automatic parking fails, and thus, the execution of the automatic parking is canceled.

When the registration of the map information is successful in the learning travel (step S12, YES), feature point detector 140 detects feature points in a camera image that captures the surroundings of vehicle 1 (step S13). In conjunction with this, notifier 180 may notify the driver that the registration of the map information has been successful in the learning travel.

Next, feature point detector 140 compares the feature points around vehicle 1 detected in the processing of step S13 with the feature points registered as map information, and determines whether a number (first number) of the feature points around vehicle 1 detected in the processing of step S13 is equal to or greater than a third number that is greater than a number (second number) of the feature points registered as the map information (step S14).

The third number is, for example, a number that is twice the second number. Herein, the third number is defined as a number twice the second number, but is not limited to this, and may be a number obtained by multiplying the second number by a value greater than 1. Alternatively, the third number may be a number obtained by adding a predetermined number to the second number.

Then, when the first number is equal to or greater than the third number (step S15, YES), traveling controller 160 controls vehicle 1 not to perform the automatic parking (step S16).

FIG. 7 illustrates a comparison between feature points 202 and 212 according to the present embodiment. The figure on the left side corresponds to image 200 and illustrates feature points 202 registered during the learning travel at night. The figure on the right side corresponds to image 210 and illustrates feature points 212 obtained during the automatic parking in the daytime.

In this case, the number of feature points 212 is equal to or greater than twice the number of feature points 202, and thus, traveling controller 160 controls vehicle 1 not to perform the automatic parking (step S16). At that time, notifier 180 may cause HMI device 20 to display a message such as “automatic parking is not possible” or may cause a speaker (not illustrated) to output a voice message, thereby notifying the driver that automatic parking is not possible.

When the number of the feature points around vehicle 1 detected in the processing in step S13 becomes greater than the number of the feature points registered as map information, there is a possibility that non-corresponding feature points may be mistakenly corresponded with each other, and there is a risk of mistakenly recognizing an object around vehicle 1. Therefore, by not performing automatic parking, it is possible to prevent an accident caused by such misrecognition.

In step S15, when the first number is not equal to or greater than the third number (step S15, NO), traveling controller 160 controls vehicle 1 to perform automatic parking (step S17).

When the registration of the map information by the learning travel has failed in step S12 (step S12, NO), notifier 180 notifies the driver by causing the HMI device 20 to display a message “the previous registration processing has failed” or by outputting a voice message from a speaker (not illustrated) (step S18).

Subsequently, state manager 110 causes vehicle 1 to execute the registration process of the map information by the learning travel as illustrated in FIG. 4 again (step S19).

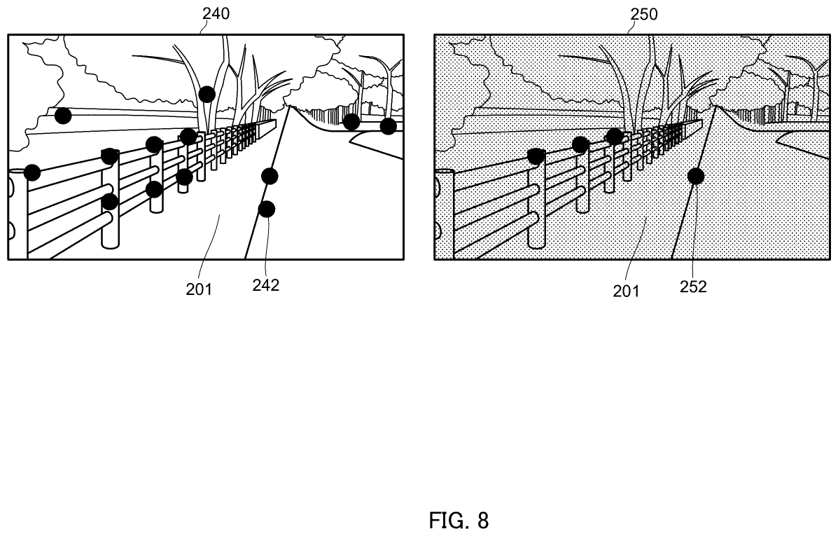

FIG. 8 illustrates feature points 242 and 252 of parking space 201 according to the present embodiment. The figure on the left side illustrates an example of feature points 242 extracted from camera image 240 captured during the learning travel in the daytime, and the figure on the right side illustrates an example of feature points 252 extracted from camera image 250 captured during the automatic parking at night.

A total of 13 feature points 242 are extracted from camera image 240 captured in the daytime. Further, a total of four feature points 252 are extracted from camera image 250 captured at night.

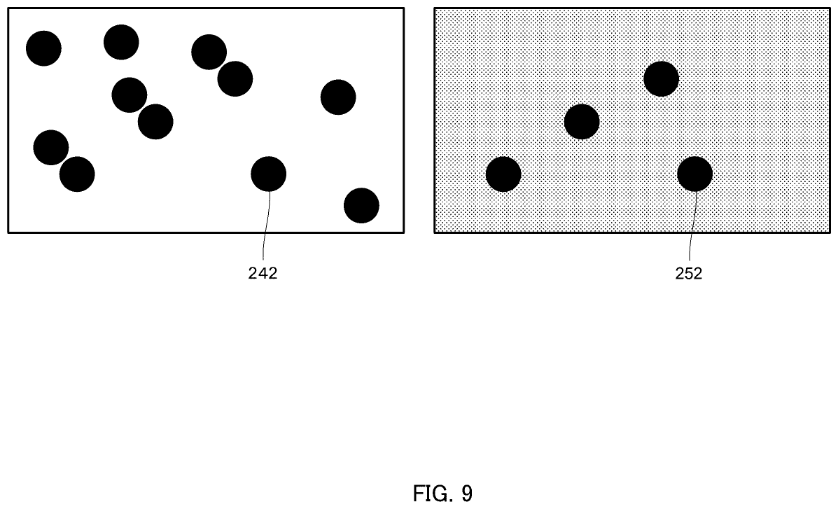

FIG. 9 illustrates a comparison between feature points 242 and 252 according to the present embodiment. The figure on the left side corresponds to image 240 and illustrates feature points 242 registered during the learning travel in the daytime. The figure on the right side corresponds to image 250 and illustrates feature points 252 obtained during the automatic parking at night.

In this case, 30% or more of feature points 252 match feature points 242, and thus, the automatic parking is possible. The matching criterion is not limited to 30%, and may be set to another value.

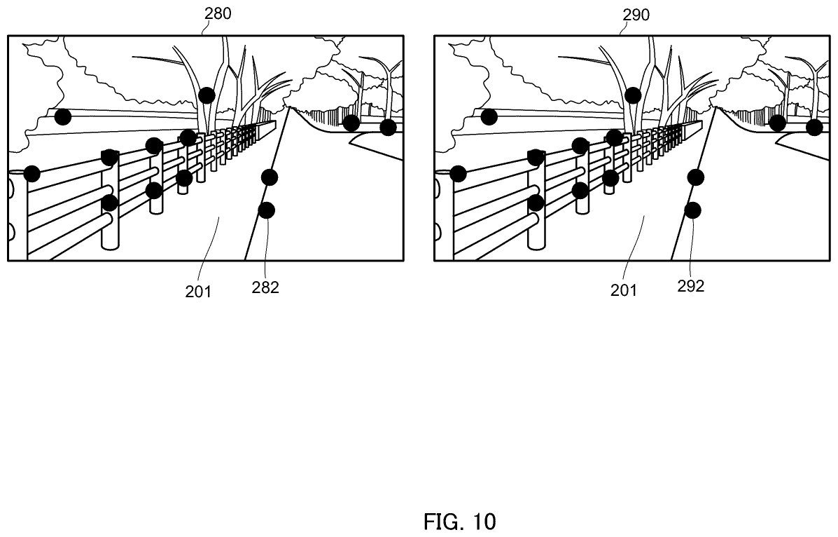

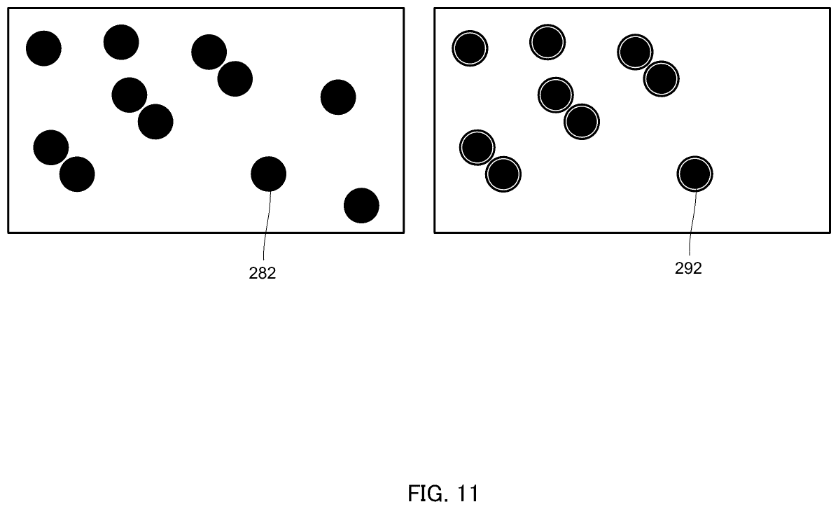

FIG. 10 illustrates feature points 282 and 292 of parking space 201 according to the present embodiment. The figure on the left side illustrates feature points 282 extracted from camera image 280 captured during the learning travel in the daytime, and the figure on the right side illustrates feature point 292 extracted from camera image 290 captured during the automatic parking in the daytime.

A total of 13 feature points 282 are extracted from camera image 280. Further, a total of 13 feature points 292 are extracted also from camera image 290.

FIG. 11 illustrates a comparison between feature points 282 and 292 according to the present embodiment. The figure on the left side corresponds to image 280 and illustrates feature points 282 registered during the learning travel in the daytime. The figure on the right side corresponds to image 290 and illustrates feature points 292 obtained during the automatic parking in the daytime.

In this case, 30% or more of feature points 292 also match feature points 282, and thus, automatic parking is possible.

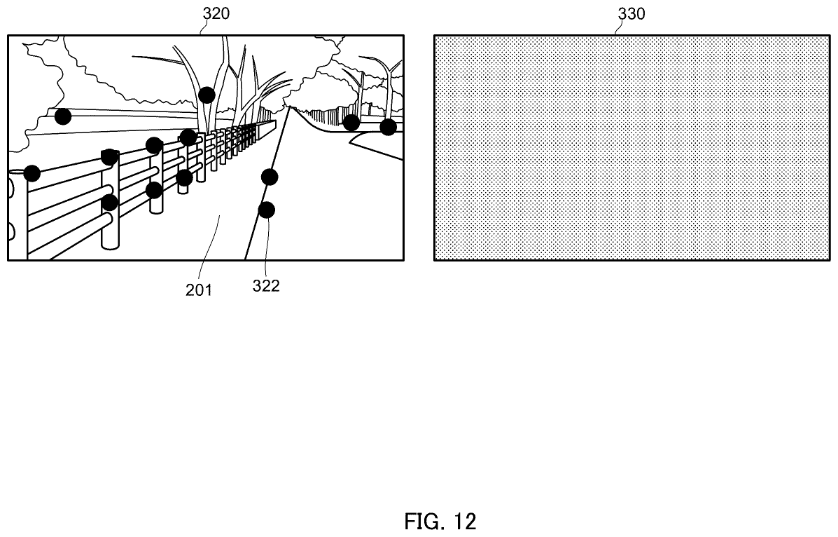

FIG. 12 illustrates feature points 322 of parking space 201 according to the present embodiment. The figure on the left side illustrates feature points 322 extracted from camera image 320 captured during the learning travel in the daytime, and the figure on the right side illustrates camera image 330 captured during the automatic parking in pitch black at night.

A total of 13 feature points 322 are extracted from camera image 320. No feature points can be extracted from camera image 330.

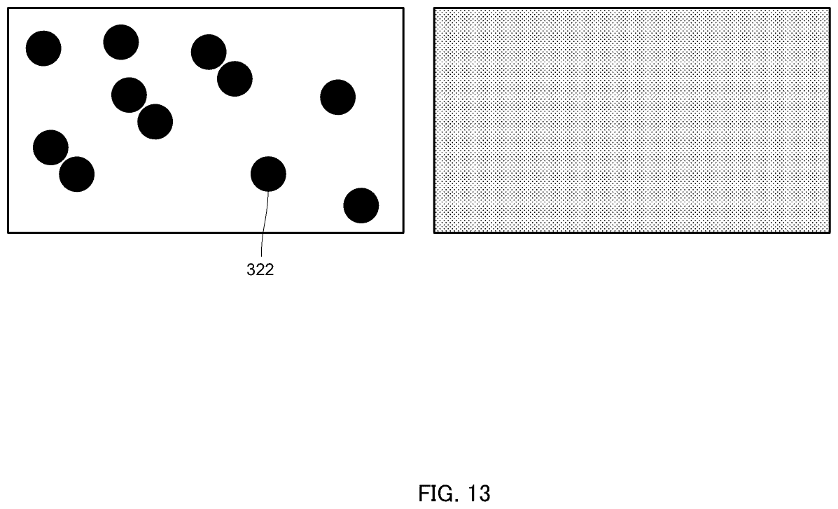

FIG. 13 illustrates a comparison for feature points 322 according to the present embodiment. The figure on the left side corresponds to image 320 and illustrates feature points 322 registered during the learning travel in the daytime. The figure on the right side corresponds to image 330, and there is no feature points obtained during the automatic parking at night.

In this case, it cannot be said that the feature point obtained during the automatic parking at night match feature points 322 by 30% or more, and thus automatic parking is impossible.

Although the embodiments have been described above, the present disclosure is not limited to the above-described embodiments.

For example, in the above-described embodiments, each component may be realized by executing a software program suitable for each component. Each component may be realized by a program execution unit such as a CPU or a processor reading and executing a software program recorded on a recording medium such as a hard disk or a semiconductor memory.

Furthermore, the general or specific aspects of the present invention may be implemented as an apparatus, a method, an integrated circuit, a computer program, or a computer-readable recording medium such as a CD-ROM, or any selective combination thereof.

In addition, the present disclosure also includes forms obtained by applying various modifications to each embodiment that a person skilled in the art may conceive, or forms realized by arbitrarily combining the components and functions of each embodiment within the scope that does not deviate from the spirit of the present disclosure.

The disclosure of Japanese Patent Application No. 2023-179790, filed on Oct. 18, 2023, including the specification, drawings and abstract, is incorporated herein by reference in its entirety.

### INDUSTRIAL APPLICABILITY

The present disclosure can be utilized for a parking assistance device, a parking assistance method, and a parking assistance program.

### REFERENCE SIGNS LIST

1 Vehicle
2 Camera
10 Operation device
20 HMI device
30 Vehicle control device
40 Navigation device
100 Parking assistance device
101 CPU
102 ROM
103 RAM
104 I/O
105 IMP
110 State manager
120 Map generator
130 Image processor
140 Feature point detector
150 Position estimator
160 Traveling controller
170 Storage
180 Notifier
200 Image
201 Parking space
202, 212, 242, 252, 282, 292, 322 Feature point

1. A parking assistance device, comprising:
a feature point detector that determines whether a first number of a plurality of feature points extracted from a camera image captured at a start position for automatic parking of a vehicle, during the automatic parking, is equal to or greater than a third number that is greater than a second number of a plurality of feature points extracted from a camera image captured at the start position during learning travel; and
a traveling controller that controls the vehicle not to perform the automatic parking when the first number is equal to or greater than the third number.

2. The parking assistance device according to claim 1, further comprising:
a notifier that gives a notification of a failure when a series of processes from extracting the plurality of feature points from the camera image captured at the start position during the learning travel up to registering the extracted plurality of feature points fails.

3. The parking assistance device according to claim 2, wherein
the notifier gives the notification of the failure when the vehicle arrives at the start position and the series of processes has previously failed.

4. The parking assistance device according to claim 2, further comprising:
a state manager that executes the series of processes again when the vehicle arrives at the start position and the series of processes has previously failed.

5. The parking assistance device according to claim 2, further comprising:
a state manager that determines whether the series of processes has been successful or not when the vehicle arrives at the start position.

6. A parking assistance method comprising:
feature-point detecting of determining whether a first number of a plurality of feature points extracted from a camera image captured at a start position for automatic parking of a vehicle, during the automatic parking, is equal to or greater than a third number that is greater than a second number of a plurality of feature points extracted from a camera image captured at the start position during learning travel; and
travel controlling of controlling the vehicle not to perform the automatic parking when the first number is equal to or greater than the third number.

7. The parking assistance method according to claim 6, further comprising:
giving a notification of a failure when a series of processes from extracting the plurality of feature points from the camera image captured at the start position during the learning travel up to registering the extracted plurality of feature points fails.

8. The parking assistance method according to claim 7, wherein
in the giving the notification, the notification of the failure is given when the vehicle arrives at the start position and the series of processes has previously failed.

9. The parking assistance method according to claim 7, further comprising:
state managing of executing the series of processes again when the vehicle arrives at the start position and the series of processes has previously failed.

10. The parking assistance method according to claim 7, further comprising:
state managing of determining whether the series of processes has been successful or not when the vehicle arrives at the start position.

11. A non-transitory computer-readable recording medium storing thereon a parking assistance program for causing a computer to execute processing, the processing comprising:
feature-point detecting of determining whether a first number of a plurality of feature points extracted from a camera image captured at a start position for automatic parking of a vehicle, during the automatic parking, is equal to or greater than a third number that is greater than a second number of a plurality of feature points extracted from a camera image captured at the start position during learning travel; and
travel controlling of controlling the vehicle not to perform the automatic parking when the first number is equal to or greater than the third number.

12. The non-transitory computer-readable recording medium according to claim 11, wherein the processing further comprises:
giving a notification of a failure when a series of processes from extracting the plurality of feature points from the camera image captured at the start position during the learning travel up to registering the extracted plurality of feature points fails.

13. The non-transitory computer-readable recording medium according to claim 12, wherein
in the giving the notification, the notification of the failure is given when the vehicle arrives at the start position and the series of processes has previously failed.

14. The non-transitory computer-readable recording medium according to claim 12, wherein the processing further comprises:
state managing of executing the series of processes again when the vehicle arrives at the start position and the series of processes has previously failed.

15. The non-transitory computer-readable recording medium according to claim 12, wherein the processing further comprises:
state managing of determining whether the series of processes has been successful or not when the vehicle arrives at the start position.
